(19) United States
(12) Patent Application Publication
(10) Pub. No.: US 2016/0052145 A1
(43) Pub. Date: Feb. 25, 2016

(54) CONFORMABLE HOLDING DEVICE

(71) Applicant: GM GLOBAL TECHNOLOGY OPERATIONS LLC, Detroit, MI (US)

(72) Inventors: John Patrick Spicer, Plymouth, MI (US); Jianying Shi, Oakland Township, MI (US)

(73) Assignee: GM GLOBAL TECHNOLOGY OPERATIONS LLC, Detroit, MI (US)

(21) Appl. No.: 14/830,278

(22) Filed: Aug. 19, 2015

Related U.S. Application Data
(60) Provisional application No. 62/038,989, filed on Aug. 19, 2014.
(60) Provisional application No. 62/038,990, filed on Aug. 19, 2014.
(60) Provisional application No. 62/038,992, filed on Aug. 19, 2014.

(51) Int. Cl. B25J 15/00; B23Q 3/08; B25J 15/06; B23Q 3/154

(52) U.S. Cl. CPC B25J 15/0052; B23Q 3/1543; B23Q 3/088; B25J 15/0085; B25J 15/00; B25J 15/0608

(57) ABSTRACT

A device for gripping a workpiece is described, and includes a holder including a base and a conformable jamming element. The conformable jamming element includes an air-impermeable pliable membrane containing filling material including magnetic particles, and is attached to the base. An electroadhesive element and a conformable releasable surface-adhesive element are secured to a surface of the membrane.

### CROSS-REFERENCE TO RELATED APPLICATIONS

This application claims the benefit of U.S. Provisional Application No. 62/038,989, filed Aug. 19, 2014, which is hereby incorporated by reference in its entirety.

This application claims the benefit of U.S. Provisional Application No. 62/038,990, filed Aug. 19, 2014, which is hereby incorporated by reference in its entirety.

This application claims the benefit of U.S. Provisional Application No. 62/038,992, filed Aug. 19, 2014, which is hereby incorporated by reference in its entirety.

### TECHNICAL FIELD

This disclosure relates to workpiece-gripping devices for fixtures, tooling, material handling and robotic end-effectors.

### BACKGROUND

Universal grippers for tooling, fixtures and robotic end-effectors advantageously employ holding devices that attach to a variety of arbitrarily-shaped workpieces for movement and placement during manufacturing and assembly processes. Universal grippers may employ some form of external power to effect gripping and release, including vacuum-based suction grippers and anthropomorphic, multi-digit grippers for grasping and manipulating workpieces.

Passive universal grippers require minimal grasp planning and include components that passively conform to unique workpiece geometries, giving them the ability to grip widely varying workpieces without readjustment. Passive universal grippers may be simple to use and may require minimal visual preprocessing of their environment. However, an ability to grip many different workpieces often renders passive universal grippers inferior at gripping any one workpiece in particular.

One passive, universal jamming gripper employs granular materials contained in a pliable membrane that conforms to a surface of a workpiece by applying a jamming force. Such operation exploits temperature-independent fluid-like characteristics of the granular materials, which can transition to a solid-like pseudo-phase with application of a vacuum inside the pliable membrane. This type of gripper employs static friction from surface contact, capture of the workpiece by conformal interlocking, and vacuum suction when an airtight seal is achieved on some portion of the workpiece surface. A jamming gripper employs static friction from surface contact, capture of workpiece by interlocking, and vacuum suction to grip different workpieces of varying shape, weight and fragility in an open loop configuration without employing grasp planning, vision, or sensory feedback.

### SUMMARY

A device for gripping a workpiece is described, and includes a holder including a base and a conformable jamming element. The conformable jamming element includes an air-impermeable pliable membrane containing filling material including magnetic particles, and is attached to the base. An electroadhesive element and a conformable releasable surface-adhesive element are secured to a surface of the membrane.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates a two-dimensional side view of a holding device including a conformable jamming element fluidly connected to a pressure source and having a controllable electroadhesive element secured onto a surface thereof, in accordance with the disclosure;

FIG. 2 schematically shows a plan view of the electroadhesive element, including a pliable substrate on which a plurality of flexible electrically conductive electrode pairs are embedded, in accordance with the disclosure;

FIG. 3 schematically illustrates a two-dimensional side view of a holding device including a conformable jamming element fluidly connected to a pressure source and having a conformable releasable surface-adhesive element secured onto a surface thereof, in accordance with the disclosure;

FIG. 4 schematically shows a bottom plan view of the conformable releasable surface-adhesive element, including a pliable substrate on which a plurality of flexible dry adhesive devices are fabricated, in accordance with the disclosure;

FIG. 5 schematically shows a side view, end view and bottom view of an embodiment of a single flexible dry adhesive device, in accordance with the disclosure;

FIG. 6 schematically illustrates a two-dimensional side view of a holding device including a conformable jamming element fluidly connected to a pressure source and containing ferromagnetic materials and a base including controllable electro-magnetic elements, in accordance with the disclosure;

FIG. 7 schematically illustrates a two-dimensional side view of a holding device including a conformable jamming element fluidly connected to a pressure source and containing ferromagnetic materials and a base including controllable electro-magnetic elements. A controllable electroadhesive element is secured onto a surface thereof, in accordance with the disclosure;

FIG. 8 schematically illustrates a two-dimensional side view of a holding device including a conformable jamming element fluidly connected to a pressure source and containing ferromagnetic particles and a base including controllable electro-magnetic elements. A conformable releasable surface-adhesive element is secured onto a surface thereof, in accordance with the disclosure;

FIG. 9 schematically illustrates a two-dimensional side view of a holding device including a conformable jamming element fluidly connected to a pressure source and containing ferromagnetic particles and a base including controllable electro-magnetic elements. A conformable releasable surface-adhesive element and a controllable electroadhesive element are secured onto a surface thereof, in accordance with the disclosure; and

FIGS. 10 and 11 each schematically shows a three-dimensional isometric view of a workpiece holder that may be in the form of a fixture, tooling or a robotic end-effector that has been configured to conformally interface with a workpiece at a plurality of gripping locations. The workpiece holder includes a plurality of holding devices, wherein each holding device is one of the holding devices described with reference to FIGS. 1-9, in accordance with the disclosure.

### DETAILED DESCRIPTION

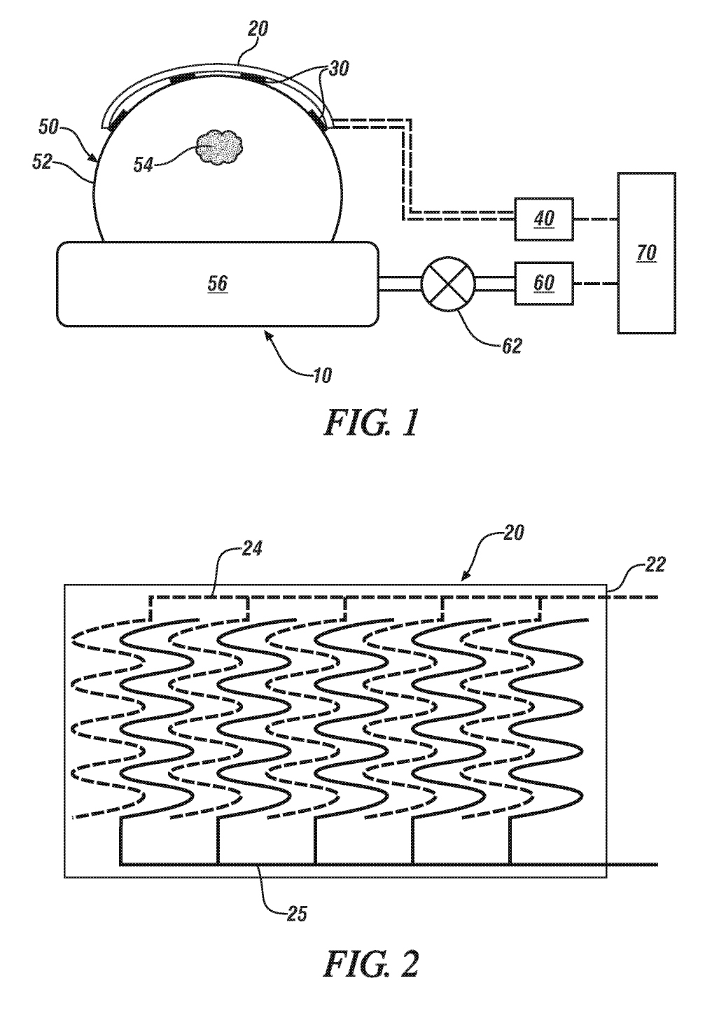

Referring now to the drawings, wherein the depictions are for the purpose of illustrating certain exemplary embodiments only and not for the purpose of limiting the same, FIGS. 1-9 schematically illustrate embodiments of a conformable holding device for gripping a workpiece, wherein the holding device includes a jamming element having a second or multiple elements for gripping a workpiece. The holding device may be employed on an end-effector of a robotic arm to controllably grip or otherwise hold onto a workpiece or assist in holding onto a workpiece to restrain the workpiece at a location or carry the workpiece to another location. Like terms and like numerals refer to like elements throughout the embodiments.

FIG. 1 schematically shows an embodiment of the conformable holding device 10 including a controllable electroadhesive element 20 secured onto a surface of a jamming element 50. The jamming element 50 includes an air-impermeable pliable membrane 52 containing granular filling material 54 that seals to and attaches to a base 56. As used herein, the term “seal” and related terms indicate closing and making secured against leakage or permeation. The base 56 attaches via suitable connectors or fasteners to an end-effector of a robotic arm in one embodiment. Suitable materials from which the membrane 52 may be fabricated include latex, vinyl, coated fabric and metal foil, among others. The membrane material is air-impermeable and is preferably resistant to tearing, e.g., by using multiple layers. Suitable material for the granular filling material 54 includes cracked corn, ground coffee and pulverized plastics among others. Preferably the granular filling material 54 has sharp or otherwise abrupt edges to effect interlocking and provide structural rigidity when jammed together. The base 56 includes a fluid conduit that connects to a controllable pressure source 60. The pressure source 60 generates negative pressure (vacuum) within the jamming element 50 in response to a first control signal to effect gripping of a workpiece, and permits vacuum release or generates positive pressure within the jamming element 50 in response to a second, subsequent control signal to effect release of the workpiece. In one embodiment, the pressure source 60 fluidly couples to the jamming element 50 through a controllable shut-off valve 62, wherein the shut-off valve 62 is open while the pressure source generates the vacuum within the jamming element 50 to effect gripping of the workpiece, is closed while the gripping is requested, and is re-opened to permit vacuum release within the jamming element 50 to effect release of the workpiece.

The controllable electroadhesive element 20 is preferably secured onto a surface of the jamming element 50 employing a plurality of re-usable attachment devices 30, e.g., hook and loop fasteners. Employing re-usable attachment devices 30 permits removal and replacement of the electroadhesive element 20. Alternatively, the controllable electroadhesive element 20 may be secured directly onto a surface of the jamming element 50 by incorporation into the filled membrane 52. The electroadhesive element 20 electrically connects to an electroadhesion activation controller 40 that controls activation thereof. A system controller 70 communicates with the activation controller 40 and the pressure source 60 to effect attachment and detachment to the workpiece.

The jamming element 50 operates by contacting and conforming to the shape of the workpiece when urged against the workpiece. A vacuum is applied to vacuum-harden the filled membrane 52 to conformally mechanically grip the workpiece. Simultaneously or immediately subsequently, the electroadhesion activation controller 40 activates the electroadhesive element 20, which electrostatically binds the workpiece to a portion of the membrane 52 that is contiguous to the workpiece. After work has been performed on the workpiece or it has been transported to another location, one or more bursts of positive pressure may be applied to reverse the fluid-like-to-solid-like phase transition, i.e., reverse the jamming. The electroadhesion activation controller 40 deactivates the electroadhesive element 20 to forcibly release the workpiece and return and thus reset the filled membrane 52 to a deformable, ready state.

The terms controller, control module, module, control, control unit, processor and similar terms refer to any one or various combinations of Application Specific Integrated Circuit(s) (ASIC), electronic circuit(s), central processing unit(s), e.g., microprocessor(s) and associated memory and storage devices (read only, programmable read only, random access, hard drive, etc.) executing one or more software or firmware programs or routines, combinational logic circuit(s), input/output circuit(s) and devices, signal conditioning and buffer circuitry and other components to provide a described functionality. Software, firmware, programs, instructions, control routines, code, algorithms and similar terms mean any controller-executable instruction sets including calibrations and look-up tables. Each controller executes control routine(s) to provide desired functions, including monitoring inputs from sensing devices and other networked controllers and executing control and diagnostic routines to control operation of actuators. Routines may be executed at regular intervals. Alternatively, routines may be executed in response to occurrence of an event, such as an external command. Communications between controllers and between controllers, actuators and/or sensors may be accomplished using a direct wired link, a networked communications bus link, a wireless link or any another suitable communications link.

FIG. 2 schematically shows a plan view of one embodiment of the electroadhesive element 20, including a pliable substrate 22 in which a plurality of flexible electrically conductive electrode pairs 24, 25 are embedded. Alternatively, the plurality of flexible electrically conductive electrode pairs 24, 25 may be embedded directly into the material of the filled membrane 52 without employing a pliable substrate 22. The electrode pairs 24, 25 are fabricated to permit elastic movement in three dimensions such that they conform with the jamming element 50 to the workpiece, and are serpentine in one non-limiting embodiment. The pliable substrate 22 is fabricated from a suitable dielectric material. The electrode pairs 24, 25 are fabricated from flexible electrically-conductive material that may include high-tensile strength metal, stretchable wire, liquid wire, helically-woven wire or another suitable material. The electrode pairs 24, 25 are also arranged onto the pliable substrate 22 in a manner that effects electroadhesion under specific conditions. When alternate positive and negative charges are induced on the electrode pairs 24, 25, the resulting electric field creates opposed charges on the surface of the substrate 22 that may facilitate adhesion to the workpiece. Such adhesion applies to a variety of workpiece materials, including, e.g., metals, carbon fiber, plastics, glass, cardboard and organic materials, among others.

Electroadhesion refers to the mechanical coupling of two objects, e.g., the electroadhesive device 20 and a workpiece, using electrostatic forces. Electroadhesion holds adjacent surfaces of the objects together or increases the effective traction or friction between two surfaces due to electrostatic forces created by an electric field that is generated in the electroadhesive device 20. Electrostatic adhesion voltage refers to a voltage that produces a suitable electrostatic force to couple the adjacent surfaces, e.g., the electroadhesive device 20 coupled to a workpiece. The electrode pairs 24, 25 form electrical conductors in close proximity that generate alternating patterns of induced current flow. The alternating patterns of induced current flow may be generated by fabricating the electrode pairs 24, 25 in alternating directions, e.g., a zigzag pattern or a spiral pattern. The electrode pairs 24, 25 are embedded in the dielectric substrate 22 so that the electric field between each of the electrode pairs 24, 25 induces coulomb charges in the dielectric substrate 22. An increase in the electric field results in an increase in charge density. When the electroadhesive device 20 is brought in contact with a workpiece, an opposite charge is established in the workpiece by the same electric field. Since the charges are opposite, they create an attractive force between them that is based upon electrical permittivity of the dielectric substrate 22. Since the material of the surface of the electroadhesive device 20 may differ from the material of the workpiece, differences in permittivity (epsilon) of the two materials must be accounted for in determining magnitude of attractive force. Distance between the dielectric substrate 22 and the workpiece must also be accounted for, with such distance being the thickness of the dielectric substrate 22 covering the electroadhesive device 20, which acts as an electrical insulator. Thus, a magnitude of gripping force is determined by permittivity (epsilon) in the material of the dielectric substrate 22 and in the material of the workpiece. Thus, the holding force will vary for different workpiece materials and is preferably accounted for in design of the electroadhesive device 20. Preferred design parameters include a relatively high voltage, a high contact surface area of contact, and a minimal thickness of the dielectric substrate 22.

The minimum voltage needed for the electroadhesive element 20 varies in relation to factors related to the surface area of the electroadhesive element 20, material conductivity and spacing of electrode pairs 24, 25, the material of the dielectric substrate 22, the surface material of the workpiece, the presence of any disturbances to electroadhesion such as dust, other particulates or moisture, the weight of any objects being supported by the electroadhesive force, three-dimensional compliance of the electroadhesive element 20, the dielectric and resistivity properties of the workpiece, and/or the relevant gaps between electrode pairs 24, 25 and a surface of the workpiece. In one embodiment, the electrostatic adhesion voltage includes a differential voltage between the electrode pairs 24, 25 that is between about 500 volts and about 15 kilovolts. Even lower voltages may be used in micro applications. In one embodiment, the differential voltage is between about 2 kilovolts and about 5 kilovolts. Voltage for one of the electrode pair 24, 25 may be zero. Alternating positive and negative charges may also be applied to adjacent electrode pairs 24, 25. The voltage on a single electrode may be varied in time, and in particular may be alternated between positive and negative charges so as to not develop substantial long-term electrostatic charging of the workpiece. The resultant holding forces will vary with the specifics of a particular electroadhesive device 20, the material it adheres to, any particulate disturbances, surface roughness, and so forth. In general, electroadhesion as described herein provides a wide range of holding pressures, generally defined as the attractive force applied by the electroadhesive device divided by the area thereof in contact with the workpiece.

The actual electroadhesion forces and pressure will vary with design and other factors. In one embodiment, electroadhesive element 20 provides electroadhesive attraction pressures between about 0.7 kPa (about 0.1 psi) and about 70 kPa (about 10 psi), although other amounts and ranges are certainly possible. The amount of force needed for a particular application may be readily achieved by varying the area of the contacting surfaces, varying the applied voltage, and/or varying the distance between the electrodes and workpiece surface, although other relevant factors may also be manipulated as desired.

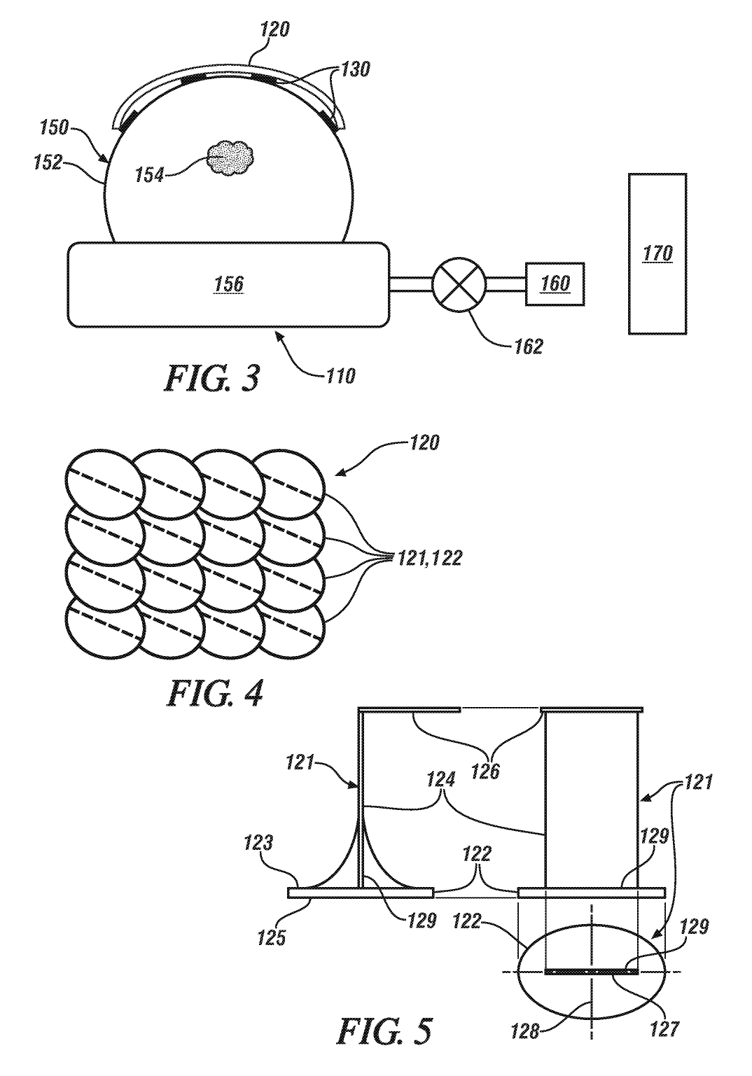

FIG. 3 schematically illustrates a two-dimensional side view of an embodiment of a conformable holding device 110 including a conformable releasable surface-adhesive element 120 secured onto a surface of a jamming element 150 that may be employed on an end-effector of a robotic arm to controllably grip or otherwise hold onto an workpiece or assist in holding onto a workpiece.

The jamming element 150 includes an air-impermeable pliable membrane 152 containing granular filling material 154 that seals to and attaches to a base 156. The base 156 attaches to an end-effector of a robotic arm in one embodiment. Suitable materials from which the membrane 152 may be fabricated include latex, vinyl, coated fabric and metal foil, among others. The membrane material is air-impermeable and is preferably resistant to tearing, e.g., by using multiple layers. Suitable material for the granular filling material 154 includes cracked corn, ground coffee and pulverized plastics among others. Preferably the granular filling material 154 has sharp or otherwise abrupt edges to effect interlocking and provide structural rigidity when jammed together. The base 156 includes a fluid conduit that connects to a controllable pressure source 160. The pressure source 160 generates negative pressure (vacuum) within the jamming element 150 in response to a first control signal to effect gripping of a workpiece, and permits vacuum release or generates positive pressure within the jamming element 150 in response to a second control signal to effect release of the workpiece. In one embodiment, the pressure source 160 fluidly couples to the jamming element 150 through a controllable shut-off valve 162, wherein the shut-off valve 162 is open while the pressure source 160 generates the vacuum within the jamming element 150 to effect gripping of the workpiece, is closed while the gripping is requested, and is re-opened to permit vacuum release within the jamming element 150 to effect release of the workpiece.

The conformable releasable surface-adhesive element 120 is preferably secured onto a surface of the jamming element 150 employing a plurality of re-usable attachment devices 130, e.g., hook and loop fasteners. Employing re-usable attachment devices 130 permits removal and replacement of the conformable releasable surface-adhesive element 120. A system controller 170 signally connects to the pressure source 160 to effect attachment and detachment to the workpiece. In certain embodiments, a single conformable releasable surface-adhesive element 120 is employed. Alternatively, multiple conformable releasable surface-adhesive elements 120 can be employed.

The jamming element 150 operates by contacting a workpiece and conforming to the shape of the workpiece. A vacuum is applied to vacuum-harden the filled membrane 152 to conformally mechanically grip the workpiece, and the conformable releasable surface-adhesive element 120 adheres the surface of the workpiece. Subsequently, e.g., after work has been performed on the workpiece or it has been transported to another location, one or more bursts of positive pressure are applied to reverse the fluid-like-to-solid-like phase transition (jamming) causing the conformable releasable surface-adhesive element 120 to peel off the workpiece and return and thus reset the filled membrane 152 to a deformable, ready state.

The conformable releasable surface-adhesive element 120 includes surface adhesion concepts that are based upon feet of geckos. Feet of geckos have natural adhesive capability that allows the animal to adhere to a variety of surface types over a range of ambient conditions. The adhesive capability may be provided by numerous hair-type extensions, called setae, on the feet of the gecko. Gecko setae include stalks having diameters in the range of 5 micrometers. At the distal end, each stalk branches out into nano-sized spatulae or pads, with roughly 100 to 1000 spatulae on each stalk, each of which is about 0.2 micrometers in length. Adhesion between the spatulae and a contacting surface is obtained due to van der Waals forces. The attractive forces between a single spatula and a surface can be on the order of 100 nano-Newtons (nN). The setae can be readily separated from the surface by the animal curling its toes off of the surface from the tips inward. This peeling action alters the angle of incidence between millions of individual spatulae and the surface, reducing the van der Waals forces and allowing the animal to move across the surface.

FIGS. 4 and 5 schematically show an embodiment of the conformable releasable surface-adhesive element 120 that includes a plurality of dry adhesive devices 121. FIG. 4 shows a bottom view of one embodiment of the conformable releasable surface-adhesive element 120 including a plurality of the dry adhesive devices 121 arranged in an overlapping configuration. FIG. 5 shows top, side and bottom views of an embodiment of one of the dry adhesive devices 121. Each dry adhesive device 121 of the conformable releasable surface-adhesive element 120 includes a pad 122 that preferably attaches to a skeleton 126 using a flexible tether 124. Each tether 124 is preferably a planar-shaped sheet that is fabricated from synthetic fabric. Each pad 122 has a planar backing layer 123 that provides a substrate for mounting an adhesive surface 125. The planar back layer 123 is fabricated from an elastic material having a high in-plane stiffness, and is a woven synthetic fabric material in one embodiment. As employed herein, the term ‘stiffness’ refers to an ability to resist deflection in response to an applied force. The adhesive surface 125 is preferably a smooth surface fabricated from an elastomer that is impregnated or otherwise attached onto the backing layer 123, and the tether 124 attaches to the pad 122 on the backing layer 123 opposing the adhesive surface 125. The skeleton 126 provides a holding component for attaching the other end of the tether 124. Each pad 122 may be an oval-shaped element having a major axis 127 and a minor axis 128, and the tether 124 preferably attaches to the pad 122 along the major axis 127, forming a tether-pad connection 129. Alternatively, each pad 122 may have a rectangular shape, a trapezoidal shape, or another suitable shape that preferably includes a major axis and a minor axis. Alternatively, the pads 122 attach directly to the skeleton 126, which attaches to the filled membrane 152. Alternatively, pads 122 attach directly to the filled membrane 152 without employing tethers 124 or skeleton 126. Large areas of interfacial contact can be designed through the combined properties of the soft elastic layer and the draping characteristics of a fabric layer. Furthermore, the elastic design provides a mechanism for repeated attachment and separation cycles without degradation in the load bearing capacity of the adhesive interface.

There is a specific designation of rotational freedom at continuous junctions, specifications of stiffness in loading direction with low flexural rigidity perpendicular to a surface of the elastic material, and the ability to achieve high capacity load support under both normal and shear loading directions with near-zero required pre-load, which refers to the amount of force that is required to establish an interface between the adhesive surface 125 and the backing layer 123 for supporting a given load. The pad 122 provides a dry adhesive structure that may be referred to as a T-pad. The pad 122 may support high loads under shear, normal, and multi-mode (i.e., peel) loadings while requiring minimal forces and energy for release or separation under specifically-designed release strategies.

The pad 122 is the basic structural element of the conformable releasable surface-adhesive element 120, which is connected to the tether 124. The tether 124 preferably maintains high stiffness in the pad 122 along the major axis 127 of loading through the tether-pad connection 129. The tether-pad connection 129 between the tether 124 and the pad 122 has pre-defined dimensions, orientation, and spatial location, according to particular needs, that can be modified to control the release strategy and provide tolerated balance of shear and normal loading.

This approach combines adhesion attributes of polymer materials and integrated mechanical designs through proper conservation of rotational freedom, low flexural modulus normal to the adhesive surface 125, and high stiffness in load bearing directions. A scaling relationship provides a framework for understanding the adhesive performance of the pad 122 over a range of size scales and geometries, and suggests that the adhesive capacity Fc of an interface is governed by three simple parameters, which are dependent on both the geometry and material properties of the interface. To design reversible adhesives which can adhere to various substrates, the interfacial interactions Gc rely upon non-specific van der Waals forces, rendering the interfacial interactions Gc an ineffective control parameter. Therefore, to scale the adhesive capacity Fc for adhesive materials the material system relies on the area on contact (A), system compliance (C) and attributes that increase and maximize a ratio of the area in relation to the system, i.e., maximize an A/C ratio. Thus, selected materials for the adhesive surface 125 are preferably pliable to increase true contact in conjunction with a stiffness in the backing layer 123 to achieve high loads. Pliable materials are able to create large-scale contact but have a high compliance when loaded, while stiff materials are unable to create extensive contact. In one embodiment, fabricating the pad 122 includes integrating a thin layer of an elastic elastomer into a surface of a fabric to form the adhesive surface 125 on the backing layer 123.

The tether 124 may be connected to the pad 122 to form the tether-pad connection 129 using any suitable method, such as conventional sewing, stitching, or gluing, which allows easy control of dimensional, orientational, and spatial location of the attachment. The tether-pad connection 129 preferably provides load sharing and load bearing capacity, and may be controlled through selection of a stitching pattern, width, and length. Appropriate stitching patterns include straight stitching, zigzag stitching, multi-zigzag stitch, satin stitching, honeycomb stitching, ladder stitch, double overlock stitch, and crisscross stitching.

For example, one embodiment of a tether-pad connection 129 is a straight-line stitching of the tether 124 to the pad 122 that is centered on the major axis 127 of the pad 122 and extends to a length that is approximately two-thirds of a chord length of the major axis 127 and perpendicular to and centered about the minor axis 128 of the pad 122. The tether-pad connection 129 preferably maintains rotational freedom while maintaining high stiffness in the direction of loading. The tether-pad connection 129 preferably maintains equal load sharing along its entire length. At a distance sufficiently far from the tether-pad connection 129, the tether 124 is integrated into the skeleton 126, which is a load bearing material that has high flexural rigidity and in-plane stiffness. The connection between the tether 124 and the skeleton 126 is preferably continuous to ensure equal load-sharing along its length. In one embodiment, one pad structure can act independently or in conjunction with an array of pads or units, which may be mounted with rotationally-free joints to a supporting substrate that can be rigid in one or more directions, for example. For certain applications, e.g., a large weight bearing shelf, multiple points for attaching the tether 124 to the pad 122 may also be employed.

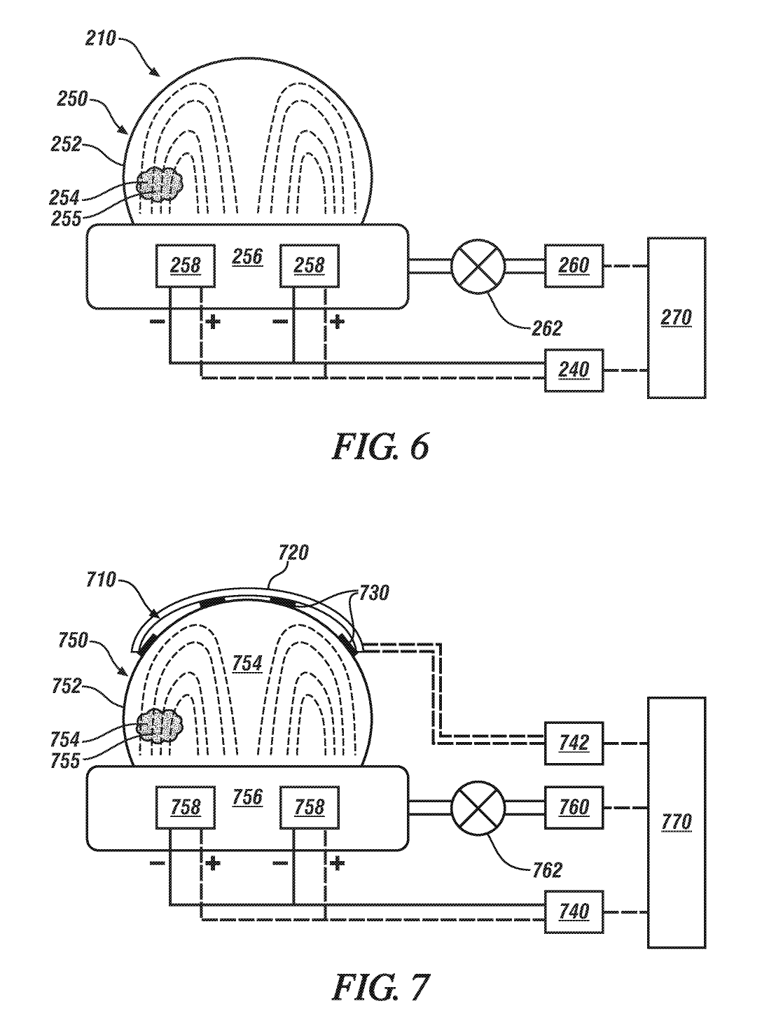

FIG. 6 schematically illustrates a two-dimensional side view of another embodiment of a conformable holding device 210 including a conformable jamming element 250 containing granular filling material 254 and ferromagnetic particles 255 and a base 256 including magnetic elements 258 in one embodiment. In one embodiment, the magnetic elements 258 may be permanent magnets. Alternatively, the magnetic elements 258 may be controllable electro-magnetic elements 258 that may be controlled by an electro-magnet activation controller 240, as shown. The holding device 210 may be employed on an end-effector of a robotic arm to controllably grip or otherwise hold onto a workpiece or assist in holding onto a workpiece to restrain the workpiece at a location or carry the workpiece to another location.

The jamming element 250 includes an air-impermeable pliable membrane 252 that contains the granular filling material 254 and the ferromagnetic particles 255 and seals to and attaches to a base 256. The base 256 attaches to an end-effector of a robotic arm in one embodiment. Suitable materials from which the membrane 252 may be fabricated include latex, vinyl, coated fabric, and metal foil among others. The membrane material is air-impermeable and is preferably resistant to tearing, e.g., by using multiple layers. Suitable material for the granular filling material 254 includes cracked corn, ground coffee and pulverized plastics among others. The granular filling material 254 may be magnetically inert. The ferromagnetic particles 255 include dry materials having a large, positive susceptibility to an external magnetic field and exhibiting a strong attraction to magnetic fields. Iron, nickel, and cobalt are examples of ferromagnetic materials. Preferably the ferromagnetic particles 255 are soft magnetic particles having high magnetic permeability, high susceptibility, and low hysteresis losses, and thus easy to magnetize and demagnetize. The base 256 includes a fluid conduit that fluidly couples to a controllable pressure source 260 via a valve 262. The pressure source 260 generates negative pressure (vacuum) within the jamming element 250 in response to a first control signal to effect gripping, and permits vacuum release or generates positive pressure within the jamming element 250 in response to a second control signal to effect release. The base 256 also includes one or an arrangement of controllable electro-magnetic elements 258 that interact with the ferromagnetic particles 255.

The controllable electro-magnetic elements 258 electrically connect to an electro-magnet activation controller 240 that controls activation thereof. A system controller 270 signally connects to the activation controller 240 and the pressure source 260 to effect attachment to and detachment from the workpiece. When the magnetic elements 258 may be permanent magnet elements, detachment from the workpiece may include use of a twisting action of the magnetic elements 258 or the workpiece.

The jamming element 250 operates by contacting and conforming to the shape of the workpiece when urged against the workpiece. A vacuum is applied to vacuum-harden the filled membrane 252 to conformally mechanically grip the workpiece. Simultaneously or immediately subsequently, the electro-magnet activation controller 240 activates the controllable electro-magnetic elements 258, which magnetically attract and bind the workpiece to a portion of the filled membrane 252 that is contiguous to the workpiece. After work has been performed on the workpiece or it has been transported to another location, one or more bursts of positive pressure may be applied to reverse the fluid-like-to-solid-like phase transition, i.e., reverse the jamming. The electro-magnet activation controller 240 deactivates the controllable electro-magnetic elements 258 to forcibly release the workpiece and return the filled membrane 252 to a deformable, ready state.

FIG. 7 schematically illustrates a two-dimensional side view of another embodiment of a conformable holding device 710 including an air-impermeable pliable membrane 752 containing granular filling material 754 and ferromagnetic particles 755 that seals to and attaches to a base 756. A controllable electroadhesive element 720 is secured onto a surface thereof, preferably employing a plurality of re-usable attachment devices 730, e.g., hook and loop fasteners. Alternatively, the controllable electroadhesive element 720 may be integrated into a portion of the membrane 752. The jamming element 750 attaches to a base 756 including magnetic elements 758, which may be permanent magnets in one embodiment. Alternatively, the magnetic elements 758 may be controllable electro-magnetic elements 758 that may be controlled by an electro-magnet activation controller 740, as shown. The holding device 710 may be employed on an end-effector of a robotic arm to controllably grip or otherwise hold onto a workpiece or assist in holding onto a workpiece to restrain the workpiece at a location or carry the workpiece to another location.

The jamming element 750 is analogous to the jamming element 50 described with reference to FIG. 1. The base 756 attaches to an end-effector of a robotic arm in one embodiment. The ferromagnetic particles 755 are analogous to the ferromagnetic particles 55 described herein. The base 756 includes a fluid conduit that fluidly couples to a controllable pressure source 760 via a valve 762. The pressure source 760 generates negative pressure (vacuum) within the jamming element 750 in response to a first control signal to effect gripping, and permits vacuum release or generates positive pressure within the jamming element 750 in response to a second control signal to effect release. The base 756 also includes one or an arrangement of controllable electro-magnetic elements 758 that interact with the ferromagnetic particles 755. The electroadhesive element 720 is analogous to the controllable electroadhesive element 20 described with reference to FIGS. 1 and 2.

The electroadhesive element 720 electrically connects to an electroadhesion activation controller 742 that controls activation thereof. A system controller 770 signally connects to the electro-magnet activation controller 740, the pressure source 760 and the electroadhesion activation controller 742 to effect attachment to and detachment from the workpiece. When the magnetic elements 758 are permanent magnet elements, detachment from the workpiece may include use of a twisting action of the magnetic elements 758 or the workpiece.

The jamming element 750 operates by contacting and conforming to the shape of the workpiece when urged against the workpiece. A vacuum is applied to vacuum-harden the filled membrane 752 to conformally mechanically grip the workpiece. Simultaneously or immediately subsequently, the electro-magnet activation controller 740 activates the controllable electro-magnetic elements 758, which magnetically attract and bind the workpiece to a portion of the filled membrane 752 that is contiguous to the workpiece. Simultaneously or immediately subsequently, the electroadhesion activation controller 742 activates the electroadhesive element 720. The action of conforming the jamming element 750 to conformally grip the workpiece, magnetically attracting the workpiece, and activating the electroadhesive element 720 binds the workpiece to the conformable holding device 710 for transporting or executing work.

After work has been performed on the workpiece or it has been transported to another location, one or more bursts of positive pressure may be applied to reverse the fluid-like-to-solid-like phase transition, i.e., reverse the jamming. The electro-magnet activation controller 740 deactivates the controllable electro-magnetic elements 758 and the electroadhesion activation controller 742 deactivates the electroadhesive element 720 to forcibly release the workpiece and return the filled membrane 752 to a deformable, ready state.

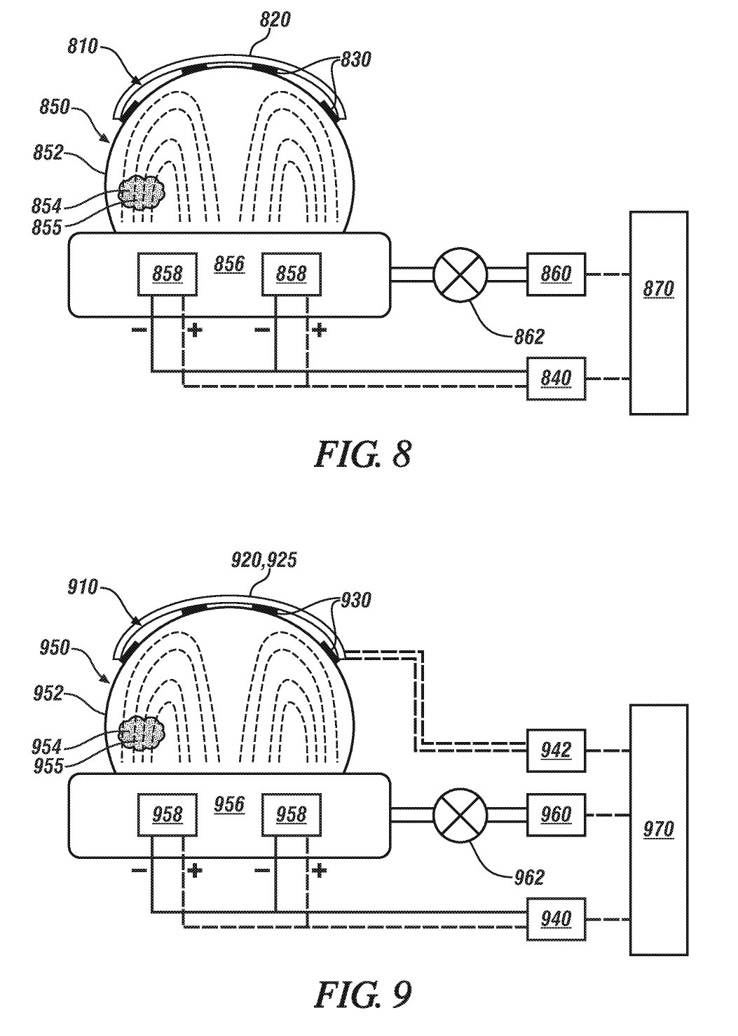

FIG. 8 schematically illustrates a two-dimensional side view of another embodiment of a conformable holding device 810 including an air-impermeable pliable membrane 852 containing granular filling material 854 and ferromagnetic particles 855 that seals to and attaches to a base 856, or alternatively, contains only ferromagnetic particles 855. A conformable releasable surface-adhesive element 820 is secured onto a surface thereof, preferably employing a plurality of re-usable attachment devices 830, e.g., hook and loop fasteners. Alternatively, the conformable releasable surface-adhesive element 820 may be integrated into a portion of the membrane 852. The jamming element 850 attaches to a base 856 including magnetic elements 858, which may be permanent magnets in one embodiment. Alternatively, the magnetic elements 858 may be controllable electro-magnetic elements 858 that may be controlled by an electro-magnet activation controller 840, as shown. The holding device 810 may be employed on an end-effector of a robotic arm to controllably grip or otherwise hold onto a workpiece or assist in holding onto a workpiece to restrain the workpiece at a location or carry the workpiece to another location.

The jamming element 850 is analogous to the jamming element 50 described with reference to FIG. 1. The base 856 attaches to an end-effector of a robotic arm in one embodiment. The ferromagnetic particles 855 are analogous to the ferromagnetic particles 55 described herein. The base 856 includes a fluid conduit that fluidly couples to a controllable pressure source 860 via a valve 862. The pressure source 860 generates negative pressure (vacuum) within the jamming element 850 in response to a first control signal to effect gripping, and permits vacuum release or generates positive pressure within the jamming element 850 in response to a second control signal to effect release. The base 856 also includes one or an arrangement of controllable electro-magnetic elements 858 that interact with the ferromagnetic particles 855. The conformable releasable surface-adhesive element 820 is analogous to the conformable releasable surface-adhesive element 20 described with reference to FIGS. 3, 4 and 5. A controller 870 provides operational control of the controllable pressure source 860 and the electro-magnet activation controller 840.

The jamming element 850 operates by contacting and conforming to the shape of the workpiece when urged against the workpiece. A vacuum is applied to vacuum-harden the filled membrane 852 to conformally mechanically grip the workpiece. Simultaneously or immediately subsequently, the electro-magnet activation controller 840 activates the controllable electro-magnetic elements 858, which magnetically attract and bind the workpiece to a portion of the filled membrane 852 that is contiguous to the workpiece. Simultaneously or immediately subsequently, a portion of the conformable releasable surface-adhesive element 820 adheres to the surface of the workpiece. The actions of conforming the jamming element 850 to conformally grip the workpiece, magnetically attracting the workpiece, and adhering to the surface of the workpiece binds the workpiece to the conformable holding device 810 for transporting or executing work.

After work has been performed on the workpiece or it has been transported to another location, one or more bursts of positive pressure are applied to reverse the fluid-like-to-solid-like phase transition, i.e., reverse the jamming. The electro-magnet activation controller 840 deactivates the controllable electro-magnetic elements 858 to forcibly release the workpiece and return the filled membrane 852 to a deformable, ready state.

FIG. 9 schematically illustrates a two-dimensional side view of a conformable holding device 910 including an air-impermeable pliable membrane 952 containing granular filling material 954 and ferromagnetic particles 955 that seals to and attaches to a base 156. A conformable releasable surface-adhesive element 925 and an electroadhesive element 920 may be secured onto a surface thereof, preferably employing a plurality of re-usable attachment devices 930, e.g., hook and loop fasteners. In one embodiment, the electroadhesive element 920 and the conformable releasable surface-adhesive element 925 may be fabricated into a single element. Alternatively, the controllable electroadhesive element 920 may be physically integrated into a portion of the membrane 952. The jamming element 950 attaches to a base 956 including magnetic elements 958, which may be permanent magnets in one embodiment. Alternatively, the magnetic elements 958 may be controllable electro-magnetic elements 958 that may be controlled by an electro-magnet activation controller 940, as shown. The holding device 910 may be employed on an end-effector of a robotic arm to controllably grip or otherwise hold onto a workpiece or assist in holding onto a workpiece to restrain the workpiece at a location or carry the workpiece to another location.

The jamming element 950 is analogous to the jamming element 50 described with reference to FIG. 1. The conformable releasable surface-adhesive element 920 is analogous to the conformable releasable surface-adhesive element 20 described with reference to FIGS. 3, 4 and 5. The electroadhesive element 920 is analogous to the controllable electroadhesive element 20 described with reference to FIGS. 1 and 2. The base 956 attaches to an end-effector of a robotic arm in one embodiment. The ferromagnetic particles 955 are analogous to the ferromagnetic particles 55 described herein. The base 956 includes a fluid conduit that fluidly couples to a controllable pressure source 960 via a valve 962. The pressure source 960 generates negative pressure (vacuum) within the jamming element 950 in response to a first control signal to effect gripping, and permits vacuum release or generates positive pressure within the jamming element 950 in response to a second control signal to effect release. The base 956 also includes one or an arrangement of controllable electro-magnetic elements 958 that interact with the ferromagnetic particles 955. A controller 970 provides operational control of the controllable pressure source 960, the electro-magnet activation controller 940 and an electroadhesion activation controller 942.

The jamming element 950 operates by contacting and conforming to the shape of the workpiece when urged against the workpiece. A vacuum is applied to vacuum-harden the filled membrane 952 to conformally mechanically grip the workpiece. Simultaneously or immediately subsequently, the electro-magnet activation controller 940 activates the controllable electro-magnetic elements 958, which magnetically attract and bind the workpiece to a portion of the filled membrane 952 that is contiguous to the workpiece. Simultaneously or immediately subsequently, a portion of the conformable releasable surface-adhesive element 920 adheres to the surface of the workpiece. Simultaneously or immediately subsequently, the electroadhesion activation controller 942 activates the electroadhesive element 920. The actions of conforming the jamming element 950 to conformally grip the workpiece, magnetically attracting the workpiece, electrostatically coupling to the workpiece and adhering to the surface of the workpiece binds the workpiece to the conformable holding device 910 for transporting or executing work.

After work has been performed on the workpiece or it has been transported to another location, one or more bursts of positive pressure may be applied to reverse the fluid-like-to-solid-like phase transition, i.e., reverse the jamming. The electro-magnet activation controller 940 deactivates the controllable electro-magnetic elements 958 and the electroadhesion activation controller 942 deactivates the electroadhesive element 920 to forcibly release the workpiece and return the filled membrane 952 to a deformable, ready state.

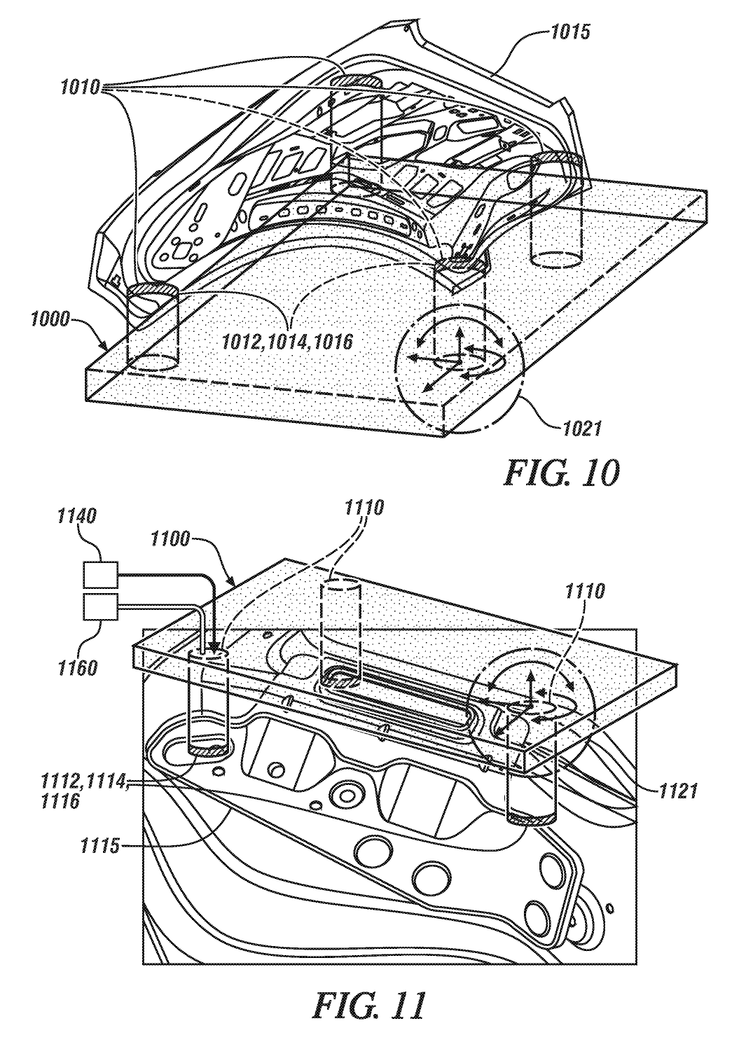

FIG. 10 schematically shows a three-dimensional isometric view of a workpiece holder 1000 that may be in the form of a fixture, tooling or a robotic end-effector that has been configured to conformally interface with a workpiece 1015 at a plurality of gripping locations. The holder 1000 includes a plurality of holding devices 1010, wherein each holding device is one of the holding devices 10, 110, 210, 710, 810 or 910 described with reference to FIGS. 1-9, and thus may include any one of or all of a conformable releasable surface-adhesive element 1012, an electroadhesive element 1014 and an electromagnetic element 1016. Each of the holding devices 1010 is configured to conformally interface with a portion of the workpiece 1015 when activated by a controller. As shown, the workpiece 1015 rests on top of the holder 1000 and the workpiece 1015 is secured thereto by conforming the holding devices 1010 to conformally grip the workpiece 1015, magnetically attracting the workpiece 1015, electrostatically coupling to the workpiece 1015 and/or adhering to the surface of the workpiece 1015 to bind the workpiece 1015 to the holding device 1010 for transporting or executing work. The holding devices 1010 are all depicted as orthogonal to a planar surface of the holder 1000, but it is appreciated that the holding devices 1010 may be arranged in any suitable orientation with reference to the holder 1000. Furthermore, as indicated by element 1021, individual ones of the holding devices 1010 may be moveable to different positions on the holder 1000, including being configured for xy-plane translation on the surface of the holder 1010, extension in a z-direction, or rotation about an x-axis, a y-axis, and/or a z-axis, i.e., pitch, yaw and/or roll rotations, thus having as many as six degrees of freedom of motion to accommodate and adapt to workpieces 1015 having different geometries. The chosen degrees of freedom may be any combination of x,y,z translations and/or pitch/yaw/roll rotations.

FIG. 11 schematically shows a three-dimensional isometric view of a workpiece holder 1100 that may be in the form of a fixture, tooling or a robotic end-effector that has been configured to conformally interface with a workpiece 1115 at a plurality of gripping locations. The holder 1100 includes a plurality of holding devices 1110, wherein each holding device 1110 is one of the holding devices 10, 110, 210, 710, 810 or 910 described with reference to FIGS. 1-9, and thus may include a jamming element with any one of, combinations of, or all of a conformable releasable surface-adhesive element 1112, an electroadhesive element 1114 and an electromagnetic element 1116. Each of the holding devices 1110 is configured to conformally interface with the workpiece 1115 when activated by a controller. As shown the workpiece 1115 suspends from and adheres to the holder 1100 with the workpiece 1115 secured thereto by conforming the holding devices 1110 to conformally grip the workpiece 1115, magnetically attracting the workpiece 1115, electrostatically coupling to the workpiece 1115 and adhering to the surface of the workpiece 1115 to bind the workpiece 1115 to the holding device 1110 for transporting or executing work. The holding devices 1110 are depicted as orthogonal to a planar surface of the holder 1100, but it is appreciated that the holding devices 1110 may be arranged in any suitable orientation with reference to the holder 1100. Furthermore, as indicated by element 1121, individual ones of the holding devices 1110 may be moveable to different positions on the holder 1100, including being configured for xy-plane translation on the surface of the holder 1110, extension in a z-direction, or rotation about an x-axis, a y-axis, and/or a z-axis, i.e., pitch, yaw and/or roll rotations, thus having as many as six degrees of freedom of motion to accommodate and adapt to workpieces 1115 having different geometries. The chosen degrees of freedom may be any combination of x,y,z translations and/or pitch/yaw/roll rotations.

Each embodiment of the holder 1100 described herein including one or a plurality of holding devices 1110 operates as follows. The holder 1100 is attached to a distal end of a robotic arm as an element of an end-effector. Initially each holding device 1110 is electrically de-energized and no vacuum is applied. The robotic arm is controlled to urge the holder 1100 against a portion of the workpiece 1115 by a force having a magnitude that is sufficient to conform the holding device 1110 to the surface of the workpiece 1115. Pressure source 1160 is activated to generate negative pressure (vacuum) within the jamming element to jam the particles to maintain the conformed shape and provide some holding force for external features. The activation controller 1140 energizes the electroadhesive element 1114 and/or the electromagnetic elements 1116. The holder 1100 may be transported by the robotic arm to a desired location to execute work on the workpiece 1115. After the work is completed, the vacuum is released and the electroadhesive element 1114 is de-energized to release the workpiece 1115. The configuration enables use of any suitable workpiece grip orientation, including internal, flat and external grips while conforming to the workpiece shape and workpiece cavities. The configuration is readily reconfigurable to different workpiece geometries.

An embodiment of a holder including one or a plurality of conformable holding devices provides a gripper element where the gripper may have one or more such elements to enable gripping a workpiece or supporting the workpiece while providing sufficient accessibility to enable welding. A workpiece holder including one or a plurality of holding devices provides a gripper element wherein the gripper may have one or more such elements to enable gripping of a workpiece while providing sufficient accessibility to enable welding or other work to be performed on or with the workpiece. One or more of the holding devices can be repositioned/reconfigured to a different location to accommodate different workpieces having differing geometries. One or more of the holding devices can be repositioned or reconfigured to a different location to accommodate different workpieces having differing geometries. A workpiece holder configured to conformally grip the workpiece, magnetically attract the workpiece, electrostatically couple to the workpiece and adhere to the surface of the workpiece binds the workpiece to the holding device for transporting or executing work. A workpiece holder including electroadhesive holding devices provides a gripper element that is able to effect an internal or flat grip to a portion of a workpiece. The workpiece holder provides a gripper element that is able to effect a combination of external, internal and/or flat grips to a portion of a workpiece through one or more of conformal gripping, magnetic attraction, electrostatic coupling and surface adhesion. The workpiece holder may be applied in any material handling situation, including but not limited to manufacturing and assembly processes, material handling and conveyancing, measurement, testing and the like.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A device for gripping a workpiece, comprising:
a holder including a base and a conformable jamming element;
the conformable jamming element including an air-impermeable pliable membrane containing ferromagnetic particles that attaches to the base; and
an electroadhesive element and a conformable releasable surface-adhesive element secured to a surface of the membrane.

2. The device of claim 1, wherein the electroadhesive element comprises a pliable substrate embedded with a plurality of flexible electrically conductive electrode pairs, each flexible electrically conductive electrode pair fabricated from one of a high-tensile strength metal, stretchable wire, liquid wire and helically-woven wire.

3. The device of claim 2, further comprising a controllable voltage source electrically connected to the electrode pairs, the controllable voltage source being energizable to induce alternate positive and negative electrical charges on the electrode pairs to generate opposed charges on the surface of the electroadhesive element.

4. The device of claim 2, wherein the pliable substrate is fabricated from dielectric material.

5. The device of claim 1, further comprising a controllable pressure device fluidly coupled to the jamming element.

6. The device of claim 1, wherein the conformable releasable surface-adhesive element includes a plurality of overlapping dry adhesive devices, each overlapping dry adhesive device including a pad attached to a tether, wherein the pad includes an adhesive surface mounted on a planar backing layer including an elastic material having high in-plane stiffness.

7. The device of claim 6, wherein each pad comprises an oval-shaped element having a major axis and a minor axis, wherein the tether is a planar sheet, and wherein the pad is attached to the tether along a straight-line portion of the major axis of the pad and centered about the minor axis of the pad.

8. The device of claim 1, wherein the conformable releasable surface-adhesive element is configured to grip a portion of the workpiece when the holding device is urged against the workpiece.

9. The device of claim 1, further comprising:
the base including a controllable electro-magnetic element; and
a controllable voltage source electrically connected to the electro-magnetic element.

10. The device of claim 1, wherein the electroadhesive element and the conformable releasable surface-adhesive element are secured on the surface of the membrane employing a plurality of re-usable attachment devices.

11. The device of claim 1, wherein the electroadhesive element and the conformable releasable surface-adhesive element are integrated into the air-impermeable pliable membrane.

12. A holder for gripping a workpiece, comprising:
a plurality of conformable holding devices, each holding device including a base including a controllable electro-magnetic element, a conformable jamming element attached to the base and including an impermeable pliable membrane containing magnetic particles, and an electroadhesive element and a conformable releasable surface-adhesive element secured to a surface of the membrane;
a controllable pressure device fluidly coupled to the jamming element;
a first controllable voltage source electrically connected to the electro-magnetic element; and
a second controllable voltage source electrically connected to electrode pairs of the electroadhesive element;
wherein the electro-magnetic elements grip portions of the workpiece in response to commands from the controller to the controllable pressure device and the first and second controllable voltage sources; and
wherein one of the conformable holding devices has freedom of motion on the holder that is adaptable to the workpiece.

13. The holder of claim 12, wherein the conformable holding device having freedom of motion on the holder that is adaptable to the workpiece comprises the holding device configured for xy-plane translation on a surface of the holder, for extension in a z-direction, and for rotation about an x-axis, a y-axis, and a z-axis in relation to the holder.

14. A device for gripping a workpiece, comprising:
a holder including a base and a conformable jamming element;
the conformable jamming element including an air-impermeable pliable membrane containing filling material including magnetic particles and attached to the base; and
one of an electroadhesive element or a conformable releasable surface-adhesive element secured to a surface of the membrane.

15. The device of claim 14, wherein the electroadhesive element comprises a pliable substrate embedded with a plurality of flexible electrically conductive electrode pairs, each flexible electrically conductive electrode pair fabricated from one of a high-tensile strength metal, stretchable wire, liquid wire and helically-woven wire.

16. The device of claim 14, wherein the conformable releasable surface-adhesive element includes a plurality of overlapping dry adhesive devices, each overlapping dry adhesive device including a pad attached to a tether, wherein the pad includes an adhesive surface mounted on a planar backing layer including an elastic material having high in-plane stiffness.

17. The device of claim 14, further comprising:
the base including a controllable electro-magnetic element; and
a controllable voltage source electrically connected to the electro-magnetic element.
